(19) United States
(12) Patent Application Publication
(10) Pub. No.: US 2009/0006033 A1
(43) Pub. Date: Jan. 1, 2009

(54) Testing Electronic Systems

(75) Inventors: Arnaud Darmont, Ieper (BE); Sam Maddalena, Ieper (BE)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Melexis NV, LEPER (BG)

(21) Appl. No.: 11/816,524

(22) PCT Filed: Feb. 17, 2006
(86) PCT No.: PCT/IB06/00326

§ 371 Date: Jul. 15, 2008

(30) Foreign Application Priority Data
Feb. 17, 2005 (GB) 0503318.8

(51) Int. Cl. G06F 15/00

(52) U.S. Cl. 702/182

(57) ABSTRACT

An imaging system comprises a local processing unit with a plurality of components or subsystems, which for the purposes of illustration comprise five variously interconnected components or subsystems, 113, 123, 133, 143, 153. Some or all of the subsystems, 113, 123, 133, 143, 153, are adapted to generate test signals. The test signals may be additional dummy pixels or lines of pixels, which are appended, embedded or injected into the normal signal path in a manner than causes them to be processed through the local processing unit in the same manner as the normal data signals or normal data stream generated by each component or subsystem, 113, 123, 133, 143, 153. In this manner the test signals acquire characteristics indicative of the performance of the components or subsystems, 113, 123, 133, 143, 153, through which they have passed. The combined data signal is output to the central processing unit 105 via data link 104. At the central processing unit, a separation unit 107 separates the combined data signal into two signals, a first signal 109 comprising the normal data signal or data stream and a second signal 108 comprising the various test signals. The first signal 109 can be processed as normal to generate the output video signal. The second signal 108 is processed and/or inspected to allow the integrity of the system (and each of its components or subsystems) to be verified.

The present invention relates to a method of testing or verifying the performance of an electronic system and particularly to testing or verifying the performance of an electronic imaging system.

Imaging devices such as digital cameras and other vision based systems are being used increasingly often in an automotive environment for implementing night vision aids, parking aids and lane following aids among other applications. Such aids typically require a plurality of imaging devices to be mounted around a vehicle, the imaging devices having a clear field of view whilst at the same time being physically protected against damage or theft. As a result, once these imaging devices have been mounted in position it is both costly and difficult to remove such imaging devices for testing or to replace faulty imaging devices. The complexity of such aids generally requires that individual imaging devices be removed for fault diagnostic testing and thus requires that functional items may need to be removed or disconnected in order to isolate faulty devices.

It is therefore an object of the present invention to address this problem.

According to the present invention there is provided a method of testing or verifying the operation of an electronic system of the type having a plurality of individual components or subsystems comprising the steps of: each individual component or subsystem generating test data; appending or embedding said test data into the normal data stream output by the component or subsystem; processing said normal data stream and said test data in accordance with the normal operation of the system; subsequently separating the test data from the normal data stream; and inspecting said test data such that the integrity of the whole system can be tested or verified.

This method allows a system to be monitored and verified in real time during operation and further allows any detected faults to be located down to subsystem or component level.

Said test data may be status data which is responsive to and indicative of the operational status of the components or subsystems. If the operation of components or subsystems are responsive to or indicative of the test data, this can provide a closed loop verification of the operation of one or more components or subsystems. The test data may be designed to test the system generally or to test one or more specific components or subsystems within the system. The test data may have characteristics designed to exercise and prove the performance of the electronic components and circuitry through it passes or by which it is processed. The characteristics of the test data may test specific components or subsystems beyond their normal operating limits to determine the reliability or operational performance of the system as a whole or of a specific component or subsystem. The test data may be beyond the normal range of signal levels, switching speed or other characteristics expected by any or all of the components or subsystems.

Said test data is preferably appended or embedded to the normal data stream steganographically. Steganographic techniques are known and used for digital watermarking. These techniques involve hiding information in a data file in such a way that the information is invisible to the casual user or observer of the data file. The information in such circumstances may be in the form of a known data string that serves to identify the source of the data file.

The test data may be separated from the normal data stream after it has passed through all or substantially all of the system. Additionally or alternatively, some or all of the test data may be separated from the normal data stream by one or more of the components or subsystems within the system. This is advantageous if test data required to test some components or subsystems is likely to cause other components or subsystems to fail.

In one preferred embodiment, the system is an imaging system. In such embodiments, the test data may be in the form of one or more additional dummy pixels. Additionally or alternatively, the test data may be in the form of one or more additional dummy video lines. Preferably, the characteristics of said dummy pixels and or said dummy lines are designed to exercise and prove the performance of the electronic components and circuitry through which they pass and by which they are processed.

According to a second aspect of the present invention, there is provided an electronic system operating in accordance with the first aspect of the present invention.

The electronic system of the second aspect of the present invention may incorporate any or all features of the first aspect of the present invention, as required or as desired.

Such a system may be provided with a separator unit operable to separate the test signals from the normal data stream. Additionally or alternatively, some or all of the components or subsystems are operable to generate or separate test date from the normal data stream.

The system may be an imaging system. Such an imaging system may comprise one or more imaging devices linked to a central processor. Such an imaging system may comprise a plurality of subsystems including but not limited to any one or more of: timing generators; buffer amplifiers; video amplifiers; biasing amplifiers; power supplies; line drivers; protection circuitry; memory systems; and control elements.

In order that it is more clearly understood, the invention will now be described further herein and with reference to the accompanying drawings, wherein:

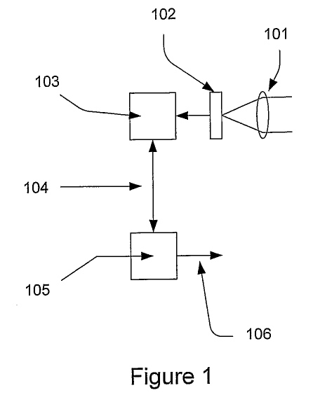

FIG. 1 is a schematic view of a typical imaging system comprising an imaging device linked to a processor; and

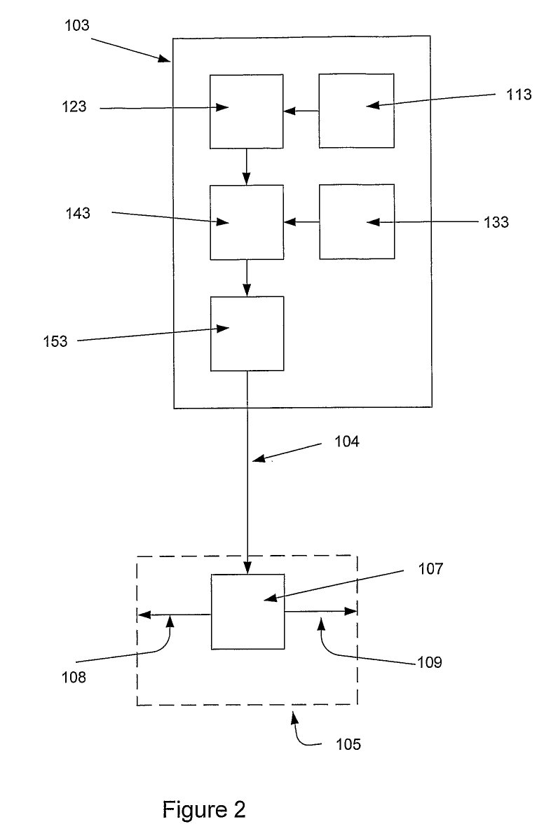

FIG. 2 is a schematic view of an implementation of a imaging system in accordance with a preferred embodiment of the invention.

Referring now to FIG. 1, in an electronic imaging system, a lens means 101 focuses an image on an image sensing means 102, which may typically comprise a plurality of light sensitive pixels. Image sensing means 102 generates electrical signals in response to and representative of said image, said electrical signals being connected to and processed by a local processing unit 103. Local processing unit 103 receives and processes said electrical signals generated by said image sensing means 102 and generates a data signal in response thereto. Said data signal is then transmitted via a connecting link 104 to a central processing unit 105. Processing electronics 105 receives processes said data signal and generates a video output 106 suitable for use by other parts of the overall system. Typically, a plurality of imaging means may be connected to said central processing unit 105.

FIG. 2 shows an implementation of an imaging system of the type shown in FIG. 1 in accordance with the present invention. In FIG. 2, the local processing unit is shown to have a plurality of components or subsystems, which for the purposes of illustration comprise five variously interconnected components or subsystems, 113, 123, 133, 143, 153, said subsystems being variously interconnected to form the local processing unit 103. hi a typical arrangement such subsystems, 113, 123, 133, 143, 153, may comprise such elements as timing generators, buffer amplifiers, video amplifiers, biasing amplifiers, power supplies, line drivers, protection circuitry, memory systems and control elements. Some or all of the subsystems, 113, 123, 133, 143, 153, are adapted to generate test signals. The test signals are of a similar nature to the normal signals processed by said components or subsystems, 113, 123, 133, 143, 153, but have characteristics or parameters arranged to exercise or test the components or subsystems, 113, 123, 133, 143, 153, across their full operating conditions.

In a preferred embodiment of the invention said test signals are in the form of additional dummy pixels or lines of pixels, which are appended, embedded or injected into the normal signal path in a manner than causes them to be processed through the local processing unit in the same manner as the normal data signals or normal data stream generated by each component or subsystem, 113, 123, 133, 143, 153. In this manner the test signals acquire characteristics indicative of the performance of the components or subsystems, 113, 123, 133, 143, 153, through which they have passed. Since the test signals are initiated by the various components or subsystems, 113, 123, 133, 143, 153, at different stages through the local processing unit 103, and each component or subsystem, 113, 123, 133, 143, 153, generates a one or more dummy pixels or dummy lines, the final output data signal is a combination of the basic data signal and the various dummy pixels or dummy lines. In some embodiments, the test signals may either incorporate status information responsive to and indicative of the operational status of the or be varied in a known manner in response to status information of the responsive to and indicative of the operational status of the component or subsystem, 113, 123, 133, 143, 153. In preferred embodiments, the test signals are appended, embedded or injected into the data stream steganograpically.

The combined data signal is output to the central processing unit 105 via data link 104. At the central processing unit, the combined data signal is received by a separation unit 107. The separation unit 107 separates the combined data signal into two signals, a first signal 109 comprising the normal data signal or data stream and a second signal 108 comprising the various test signals. The first signal 109 can be processed as normal to generate the output video signal. The second signal 108, is processed and or inspected to allow the integrity of the whole system to be verified. It also enables any faults to be located down to the particular component or subsystem 113, 123, 133, 143, 153, by analysis of the path that any signals not having expected values would have taken through the processing unit 103.

It is of course to be understood that the present invention is not to be restricted to the details of the above embodiments which are described by way of example only. For instance, although the invention has been described using the specific example of an imaging system, it may be adapted and applied to other electronic systems by using test signals of a suitably adapted form.

It is also envisaged that test signals need not pass through the whole of the system. Some components or subsystems could be adapted to separate test signals from their input data stream and verify the operation of components which output data to them. This can be beneficial if the data required to adequately test one component or subsystem is liable to cause failure or other misperformance of another component or subsystem.

1. A method of testing or verifying the operation of an electronic system of the type having a plurality of individual components or subsystems comprising the steps of:
each individual component or subsystem generating test data;
appending or embedding said test data into the normal data stream output by the component or subsystem;
processing said normal data stream and said test data in accordance with the normal operation of the system;
subsequently separating the test data from the normal data stream; and
inspecting said test data such that the integrity of the whole system can be tested or verified.

2. A method as claimed in claim 1 wherein the test data is status data which is responsive to and indicative of the operational status of the components or subsystems.

3. A method as claimed in claim 1 wherein the test data is designed to test the system generally.

4. A method as claimed in claim 1 wherein the test data is designed to test one or more specific components or subsystems within the system.

5. A method as claimed in claim 1 wherein the characteristics of the test data test specific components or subsystems beyond their normal range of signal levels, switching speed or other characteristics.

6. A method as claimed in claim 1 wherein the test data is appended or embedded to the normal data stream steganographically.

7. A method as claimed in claim 1 wherein the test data is in the form of a known data string that serves to identify the source of the data file.

8. A method as claimed in claim 1 wherein the test data is separated from the normal data stream after it has passed through all or substantially all of the system.

9. A method as claimed in claim 1 wherein some or all of the test data are separated from the normal data stream by one or more of the components or subsystems within the system.

10. A method as claimed in claim 1 wherein the system is an imaging system.

11. A method as claimed in claim 10 wherein the test data is in the form of one or more dummy pixels.

12. A method as claimed in claim 10 wherein the test data is in the form of one or more additional dummy video lines.

13. An electronic system operating in accordance with the method of claim 1.

14. A system as claimed in claim 13 wherein the system is provided with a separator unit operable to separate the test signals from the normal data stream.

15. A system as claimed in claim 13 wherein some or all of the components or subsystems of the system are operable to generate or separate test data from the normal data stream.

16. A system as claimed in claim 13 wherein the system is an imaging system.

17. A system as claimed in claim 16 wherein the imaging system comprises one or more imaging devices linked to a central processor.

18. A system as claimed in claim 16 wherein the imaging system comprises a plurality of subsystems including any one or more of: timing generators; buffer amplifiers; video amplifiers; biasing amplifiers; power supplies; line drivers; protection circuitry; memory systems; and control elements.
